(19) United States
(12) Patent Application Publication
(10) Pub. No.: US 2026/0297844 A1
(43) Pub. Date: Oct. 1, 2026

(54) SYSTEM FOR EVERTING A GARMENT

(71) Applicant: Silana GmbH, Wien (AT)

(72) Inventors: Michael MAYR, Wien (AT); Michael HOFMANNRICHTER, Baden (AT); Anton WOHLGEMUTH, Stainz (AT); Urs HUNZIKER, Meilen (CH)

(73) Assignee: Silana GmbH, Wien (AT)

(21) Appl. No.: 19/489,854

(22) PCT Filed: Jun. 6, 2024
(86) PCT No.: PCT/EP2024/065613

§ 371 Date: Dec. 3, 2025

(30) Foreign Application Priority Data
Jun. 7, 2023 (DE) 10 2023 114 973.3

(51) Int. Cl. D06G 3/02; B25J 11/00; B25J 13/08; B25J 15/00

(52) U.S. Cl. CPC D06G 3/02; B25J 11/00; B25J 13/085; B25J 13/087; B25J 15/0071

(57) ABSTRACT

The present disclosure relates to a system for robot-assisted eversion of a garment consisting of superimposed first and second fabric layers. The system comprises a handling robot with an effector comprising a handling mechanism configured to space the first fabric layer from the second fabric layer to provide an inner volume between the first fabric layer and the second fabric layer accessible through an opening between the fabric layers. Furthermore, the system comprises an eversion device configured such that a pass-through portion of the garment relative to an outer portion of the garment can be passed through the inner volume and through the opening such that an eversion of the garment can be carried out.

This application is a national US phase of PCT/EP2024/065613 which claims the benefit of the filing date of German Patent Application No. 10 2023 114 973.3 filed 7 Jun. 2023, the disclosure of which is hereby incorporated herein by reference.

### TECHNICAL FIELD

The present disclosure relates to a system and a method for robot-assisted eversion of a garment.

### BACKGROUND OF THE DISCLOSURE

In the technical field of textile processing, it is an aim to increase the degree of automation in order to reduce personnel costs and correspondingly production costs.

Textile products or garments typically have an outer, beautiful side and an inner, left side, in which the seams of the sewn-together fabric layers of the garment are visible. In the production of textile products or garments, production is typically carried out on the left, so that the seams are later not visible and the right, beautiful side lies protected on the inside during production. In the case of two fabric layers, the inner side of the fabric is respectively draped to the outside and then sewn. However, this also means that, after sewing, the textiles have to be everted (German: umgestülpt) over from the inside to the outside.

The eversion (German: Umstülpen) of the garment after production is typically carried out manually or with partially automated aids, without it being possible to achieve full automation.

### SUMMARY OF THE DISCLOSURE

There may be a need to provide a fully automatic system for eversion of garments during production, which in particular permits a high degree of reliability and permits little fold formation.

This need is met with a system and a method for robot-assisted eversion of a garment according to the independent claims.

According to a first aspect of the present disclosure, a system for robot-assisted eversion of a garment consisting of superimposed first and second fabric layers is described. The system comprises a handling robot with an effector comprising a handling mechanism configured to space the first fabric layer from the second fabric layer (in a predetermined distance) to provide an inner volume between the first fabric layer and the second fabric layer accessible through an opening between the fabric layers. Furthermore, the system comprises an eversion device configured such that a pass-through portion (German: Durchreichabschnitt) of the garment relative to an outer portion of the garment can be passed through the inner volume and through the opening such that an eversion of the garment can be carried out.

According to a further aspect, a method for robot-assisted eversion of a garment consisting of superimposed first and second fabric layers is described. The method comprises spacing the first fabric layer from the second fabric layer by means of a handling mechanism of an effector at a handling robot to provide an inner volume between the first fabric layer and the second fabric layer accessible through an opening between the fabric layers.

Furthermore, according to the method, the garment is everted by means of an eversion device, wherein a pass-through portion of the garment relative to an outer portion of the garment is passed through the inner volume and through the opening by means of the eversion device such that an eversion of the garment is carried out.

The handling robot comprises the effector to which the corresponding handling mechanism is attached, in particular exchangeably. The handling robot is fastened to the floor or to the work table with a stationary robot base to introduce corresponding forces into the corresponding system. Alternatively, the handling robot can also be configured such that the robot base is configured to be movable along the floor. A robot arm can be arranged between the effector and the robot base, which for example comprises one or more joints to thus control the effector into a desired position.

The handling robot is a programmable multi-purpose handling device for moving material, workpieces, tools or special devices. In particular, the handling robot is configured to handle or manipulate the fabric layers and to move and position them accordingly. In other words, the handling robot enables a machine-controlled position change possibility in more than one axis and/or along a translational position change of the fabric layers.

The term fabric layer denotes the possible textiles or textile parts of a textile product, in particular of a garment. The term fabric layer includes different knitted forms, in particular woven and non-woven fabrics. The inner side (i.e. the fabric underside, fabric inner side or the “not beautiful side” of a fabric layer denotes the left/left side of a fabric layer. In the case of a garment, the left side corresponds to the non-visible side of the fabric layer. The “beautiful side” of a fabric or fabric layer is used as the right/right side of a fabric layer (e.g. the fabric upper side, visible side, fabric outer side). In the case of a garment, the right side corresponds to the visible side of the fabric or the fabric layer (e.g. the outer side of a T-shirt). Furthermore, a fabric part can consist of a plurality of fabric layers. For example, a fabric part (such as for example a garment) can be folded multiple times and can rest on a work table as a fabric layer stack with a plurality of fabric layers. Alternatively, the fabric layers can respectively represent separate fabric parts which form a fabric layer stack on top of each other.

The garment according to the disclosure accordingly has fabric layers which are laid on top of each other and which are fastened to each other for example along two joining regions, e.g. seams, weld points or adhesive strips. Furthermore, the two fabric layers can be formed in one piece from a folded fabric layer, wherein the two fabric layers are joined together, for example sewn together, in a common joining region (for example round socks).

The controllable handling mechanism is arranged at the effector. In particular, the handling mechanism can space the fabric layers of a garment which are laid on top of each other from each other. The handling mechanism can for example grip the uppermost fabric layer or fasten and lift it in some other way, so that a spacing and accordingly the inner volume are formed. Furthermore, the handling mechanism can comprise a compressed air device which blows an air cushion between the first and the second fabric layer by means of compressed air. Furthermore, the handling mechanism can fasten one of the fabric layers in such a way that handling or transporting of the entire garment is possible. For this purpose, for example, the effector or the handling robot can be controlled accordingly.

Therefore, automatic packaging of textile products or garments can be enabled by means of the handling mechanism, since, in addition to the transport of the garment to the eversion device, a transport to a joining unit, such as for example a sewing machine, or to a specific storage point of the garment is also enabled. Between the process steps of providing, processing and everting of a garment or the fabric layers thereof, fully automatic processes can proceed without a process interruption or manual intervention being necessary. After the everting, the handling device can replace the everted garment, transport it further to the final processing or feed it to a final processing.

The handling mechanism operates in particular the preliminary work for the eversion device, since the handling mechanism provides an accessible inner volume of the garment, so that the eversion device can evert the garment. The eversion device moves a pass-through portion of the garment relative to an outer portion of the garment through the inner volume and through the opening such that an eversion of the garment can be carried out. The pass-through portion describes the portion of the garment which is passed through the opening for eversion. Either the pass-through portion of the garment can be fixed and the outer portion can be moved relative to the pass-through portion or the outer portion is fixed and the pass-through portion of the garment is moved relative to the outer portion. In other words, the pass-through portion can be held stationary in the inner volume and the outer portion of the garment can be pushed over the pass-through portion.

The eversion device is configured to move the eversion process, i.e. the pass-through portion relative to the outer portion of the garment, in order to carry out an eversion completely. The eversion device can, for example, as described in some examples in the following, comprise a gripping device and grip the pass-through portion in the interior of the inner volume and pass it through the opening relative to the outer portion. In addition to mechanical gripping devices, for example, the necessary force for passing through the pass-through portion can likewise be carried out by means of fluid forces, for example by means of compressed air, or based on the action of gravity.

With the system according to the disclosure, the garment can thus be provided in a predetermined position by means of the handling mechanism, i.e. with a formed inner volume accessible through the opening, and everted by means of the eversion device. A fully automatic eversion can thus be provided on the one hand. By means of the handling mechanism, which is controllable by means of a handling robot, the eversion process can furthermore be integrated into a fully automatic production for producing a garment.

According to an exemplary embodiment, the handling mechanism is configured to handle at least the first fabric layer and to space it from the second fabric layer, wherein the handling mechanism is selected from the group consisting of grippers, sucking units, clamps, regions with increased friction and/or electrostatic attraction, magnet devices (in particular an electromagnet for attracting a ferromagnetic counterplate), holding needles, rollers, freezing grippers, and/or Bernoulli grippers. The handling mechanism is, for example, selected from the group consisting of grippers, sucking units, clamps, regions with increased friction and/or electrostatic attraction, holding needles, rollers, freezing grippers, and/or Bernoulli grippers.

An effector can also comprise a plurality of handling mechanisms. For example, a handling mechanism can comprise two opposing rollers to form an eversion, so that the eversion can be gripped more easily.

Electroadhesive grippers for electrostatic attraction work with electrostatic fields. Holding forces are generated by polarization. They can be generated on the upper side of the fabric layer, which is in contact with a gripper dielectric of the electroadhesive gripper.

A Bernoulli gripper comprises a suction body, wherein compressed air is flowed outward between the fabric part and the suction body along the x-y plane via a flow channel of the suction body at the edge regions of the suction body. An air opening, which is coupled to the flow channel, is located in the center of the suction body. Due to the Bernoulli effect, air is sucked into the flow channel from the direction of the fabric part. A fixing force of the fabric part at the suction body is thus generated.

A freezer gripper comprises a strongly cooled contact surface with the fabric part, as a result of which frozen water or ice as an adhesive adheres the fabric part to the contact surface. The water can be drawn as an adhesive from the atmosphere (air humidity) or can be added by an adhesive supply.

According to a further exemplary embodiment, the handling mechanism comprises a holding needle device which is configured such that a penetration depth and/or a penetration angle of at least one holding needle into the first fabric layer and/or the second fabric layer is controllable, in particular in real time and/or based on a sensor feedback. The holding needle device is configured to move the holding needles with a stroke length (German: Hublänge) of less than 6 mm, in particular less than 4.5 mm or less than 3 mm in the direction of the garment. The holding needles in particular have a diameter of less than 1300 micrometres, 900 micrometres, in particular less than 550 micrometres, further in particular less than 250 micrometres.

The holding needle device is configured to introduce holding needles into the for example first uppermost fabric layers for fixing. By means of the holding needle device, one or more needle-like pins or holding needles can be driven from the effector side or from an auxiliary system (for example auxiliary plate, needle band) out of a magazine into or through the uppermost first fabric layer in order to fasten to the effector and lift it from the second fabric layer lying below, in order thus to form the inner volume. The holding needle device in particular comprises a feeding device, for example a holding needle magazine, which is configured to feed holding needles for the holding needle device.

An additional form of differentiated gripping can relate to the depth of a penetrating needle or holding needle and/or the angle of a holding needle (and in particular a plurality thereof). Thus, for example, a holding needle can be inserted into the fabric layer at a shallow angle or not so deep during singulation, whereas in the case of thicker fabric layers a steeper angle or a larger penetration depth can be used in order to securely access the fabric layer or the fabric layers. Thus, for example, a needle for the transport of a garment (which then substantially consists of the first and second fabric layers) can be inserted into the fabric part at a steeper angle or deeper, whereas for opening the uppermost first one a shallower angle or a smaller penetration depth is used in order to ensure that only the uppermost fabric layer is held by the effector in order to form the inner volume.

According to a further exemplary embodiment, the holding needles have a diameter of less than 1300 micrometres, less than 900 micrometres, in particular less than 550 micrometres, further in particular less than 250 micrometres. It has been found that in the case of fine microneedles as holding needles in combination with a suitable vacuum underpressure and a suitable air flow, no quality-disturbing effects remain on the fabric surface after processing. This has been shown especially in the case of needle diameters of less than 1300 micrometres, less than 900 micrometres, in particular less than 550 micrometres, preferably less than 250 micrometres.

The holding needle device is configured such that the holding needles can be moved in a relatively short stroke length by the effector in the direction of the fabric layer to be lifted, in particular with a stroke length of less than 6 mm, in particular less than 4.5 mm or less than 3 mm in the direction of the garment. It has turned out that short stroke lengths are of particular advantage, since due to the lower weight of the needles, they can be ejected more quickly and thus penetrate more easily into the fabric taking into account the mass inertia.

According to a further exemplary embodiment, the system has a sewing machine which is couplable to a work table. The handling mechanism is configured to feed a fabric layer stack consisting of the first fabric layer and the second fabric layer to the sewing machine, wherein joining regions of the fabric layers are freely accessible for the sewing machine. The sewing machine is configured to sew the joining regions, wherein the handling mechanism is configured to guide the fabric layer stack relative to the sewing machine during the sewing.

According to a further exemplary embodiment, the handling mechanism is configured to convey the sewn fabric layer stack from the sewing machine to the eversion device. According to a further exemplary embodiment, the handling mechanism is configured to convey the everted garment from the eversion device to a further processing location.

The handling robot is coupled to a control unit, which knows the operating parameters and position data of the individual functional units, such as for example the sewing machine or the eversion device, or can obtain them from the described sensor units or from a database. One and the same handling robot can accordingly feed the garment and/or the fabric layers to the joining unit and then to the eversion device. Furthermore, the handling robot is controllable by the control unit such that the handling robot handles and positions the fabric layers during the sewing (joining) and also during the eversion process. It has been shown that it is efficient if the handling robot performs more than one activity due to position knowledge. For this reason, it is advantageous if more than only the eversion is performed by the same robot (for example previously sewing or subsequently folding). On the one hand, different tasks can thus be performed without major interruptions due to a resumption of the fabric layers, on the other hand, the formation of folds can thus also be reduced since there is no need to re-grip (German: Umgreifen).

According to a further exemplary embodiment, the system has a sensor unit for determining an eversion progress at the eversion device, wherein the sensor unit detects sensor data which are indicative of the eversion progress or of a fold formation of the garment. The sensor unit in particular comprises an optical sensor for optically recording the garment, a 3D sensor, a distance sensor (in the Z-direction, i.e. for example the distance between the effector and the first or second fabric layer) and/or a scanning sensor for scanning a contour of the garment. The progress of an eversion process can be detected by means of analysis of the sensor data, in particular by means of a control unit. It can thus be ensured that the garment is completely everted, in particular using a sensor, preferably using mechanisms of artificial intelligence, wherein conclusions about the quality of a current eversion process can be drawn from the quality of past eversion processes. An increase in the reliability of the method is thereby achieved since an automatic sorting can take place in the event of a error.

Characteristic values for the quality or the progress of an eversion process can be derived from the analysis of the measured fold formation, the position of specific regions of the garment (sleeve, button strips, etc.), measurement of a location-dependent weight (collar portion weighs for example more than one sleeve portion of a garment, the position of the portions can be determined therefrom and accordingly the progress of the eversion process), analysis of the shape deviation from a desired shape of the garment after eversion (for example by means of the optical sensor). Furthermore, an AI unit (AI=artificial intelligence), which can for example be integrated in the control unit, can in particular be coupled to the optical sensor, so that the AI unit evaluates the recorded images of the optical sensor based on image recognition or image analysis methods. Based on desired data or based on empirical data from previous eversion analyses, which were evaluated and are thus available to the AI unit, the AI unit can evaluate how the progress of the eversion process is or whether the eversion process was successful.

According to a further exemplary embodiment, the sensor unit is configured to determine a marker element on the garment, which marker element is indicative of an eversion progress. The sensor unit for example comprises an optical sensor for determining a color pattern as marker element on the garment. The marker element is for example fastened at a predetermined location in the garment, so that conclusions about the quality and the progress of the eversion can be drawn based on the position and/or the shape of the marker element.

Furthermore, the sensor unit can be configured to detect an optical marking, in particular ultraviolet ink, as marker element on the garment in the non-visible region of the light. The optical marking can for example be arranged on the garment in a washable manner. The position and the pattern of the optical marking can be determined, and thus a position before and/or after the eversion can be determined.

Furthermore, the sensor unit can comprise a magnetic sensor for determining a magnetic element, so that a magnetically detectable marker element in the garment can be detected and accordingly a position recognition can be carried out with the magnetic sensor.

Furthermore, the sensor unit can comprise a force sensor for determining a stiffness range of the garment as marker element. For example, a fabric layer stack of the garment comprising two fabric layers which rest on a work table is softer and/or lighter with the same compressive force than if only one fabric layer rests on a work table.

According to a further exemplary embodiment, the system has a further sensor unit for determining a material of the garment, wherein the further sensor unit is coupled to the handling mechanism such that the handling mechanism is controllable based on the material of the garment. The further sensor unit can for example represent an optical sensor which records optical image data, so that the material or the textile material of the garment can be accessed on the basis of an image analysis.

The recognition of errors or faults is improved if the grip of the handling mechanism is monitored by means of sensors. Thus, for example, a two-part metallic gripper of the handling mechanism can be electrically insulated between the clamping gripping elements. A slipping of the fabric out of the gripper or an unsuccessful gripping can be recognized and correspondingly handled on the basis of the change in resistance between the two insulated components.

According to a further exemplary embodiment, the system has the control unit, which is configured to obtain from a sensor unit (for example the above-described sensor units) or from a database unit garment data relating in particular to fabric layer material and/or fabric layer geometry, left/right orientation, local positioning, unfolding and/or production quality of the garment.

The control unit is further configured to collect and/or evaluate garment data with regard to manipulation, positioning, placement, fixing and/or sewing by the handling robot, wherein the control unit is configured to control the handling robot, the eversion device and/or the sewing machine based on the garment data.

The handling robot thus transfers information details for processing the garment to a subsequent handling system or joining system for the next work step and/or obtains information details from a preceding work step. The demanding new recording of position details, material details and/or left/right placement of the fabric part can thereby be dispensed with. It has turned out that in particular details with regard to material properties, left/right orientation, location, unfolding and/or production quality are of particular advantage.

The control unit analyzes the sensor data as to whether the respective manipulation, positioning, placement, fixing and/or sewing of the garment was successful. A change in the reliability can thus be recognized and communicated to a higher-level system or the control unit. Preventive maintenance or an adaptation of the handling parameters can thereby be initiated, for example. To this end, the control unit can also receive information, for example from the sewing machine.

Coordinates for the step of opening and/or eversion are thus obtained from a preceding production step, preferably coordinates for a gripping position for the eversion and/or the opening of the inner volume. If the method according to the disclosure or the system is directly attached to an automated production, a set of coordinates can be adopted from the automated production, which set of coordinates contains suitable gripping points for the gripping through before the pulling, and the complex search for the suitable point for the pulling through for eversion is thus dispensed with.

With the present disclosure, the sensor unit determines the position of the garment or of the fabric layers before contact with the handling mechanism, for example before the gripping, in order thus to prevent a false manipulation, so that a countermeasure, for example a new corrected gripping process, is initiated. The recognition of errors or faults is also improved if it is ensured by means of sensors (before the access) that the fabric is also available at the desired location and/or is not covered with other fabric (e.g. due to ball formation). This can be achieved for example by means of optical sensors, in particular cameras, as sensor unit and a downstream image processing unit (e.g. in the control unit). Depending on this, the eversion process can be aborted or a countermeasure can be initiated, such as for example a new positioning of a gripper of the handling mechanism.

According to a further exemplary embodiment, the eversion device is configured such that the garment can be aligned such that the pass-through portion can be passed through the opening by means of gravitational force such that an eversion of the garment can be carried out. The eversion device comprises for example a fixing device with a fall-through opening, such as for example a work table with a hole or a vertically arranged tube, wherein the eversion device comprises fixing elements, such as for example grippers, which fasten the outer portion of the garment to the edge of the fall-through opening, in particular such that the opening of the garment and the fall-through opening form a common passage. The handling mechanism can position the pass-through portion such that it is present above the fall-through opening in the direction of gravity. The handling mechanism now releases the pass-through portion completely or partially such that the released portion of the pass-through portion falls through the opening of the garment and through the fall-through opening in the direction of gravity (direction of gravity) relative to the outer portion such that an eversion of the garment occurs. After the performed eversion process, the outer portion can be released from the eversion device and the garment can be transported further by means of the handling device.

According to a further exemplary embodiment, the eversion device comprises a suction device, wherein the eversion device is configured such that the pass-through portion can be sucked through the opening by means of a suction force, and/or wherein the eversion device is configured such that the pass-through portion can be fixed and the outer portion can be guided over the pass-through portion by means of suction force. The suction device can accordingly suck the movable region, i.e. the pass-through portion or the outer portion such that the pass-through portion can be moved relative to the opening such that it is sucked through the opening (for example by means of a corresponding movement of the pass-through portion or a movement of the outer portion) in order to achieve an eversion.

According to a further exemplary embodiment, the eversion device comprises a compressed air device, wherein the eversion device is configured such that the pass-through portion can be blown through the opening by means of compressed air. The eversion device is configured such that the pass-through portion can be fixed and the outer portion can be guided over the pass-through portion by means of compressed air. The compressed air device can accordingly move the movable region, i.e. the pass-through portion or the outer portion, by means of compressed air such that the pass-through portion can be moved relative to the opening such that it is blown through the opening (for example by means of a corresponding movement of the pass-through portion or a movement of the outer portion) in order to achieve an eversion.

According to a further exemplary embodiment, the eversion device comprises a gripping device, wherein the gripping device is configured to grip the pass-through portion through the opening and to guide it through the opening relative to the outer portion. In a further exemplary embodiment, the eversion device is configured such that the pass-through portion of the garment can be fixed and the gripping device is configured to grip the outer portion and to guide the outer portion over the pass-through portion, wherein the gripping device is arranged in particular at the effector.

According to a further exemplary embodiment, the eversion device comprises an eversion aid, which can be introduced between the first fabric layer and the second fabric layer in order to stabilize the inner volume or to hold the garment in the opened, spanned state. The handling robot is configured to fasten the garment to the eversion aid, in particular by means of pulling over the garment. The eversion aid in particular comprises a beam-shaped element or a hollow body, in particular a tube. Furthermore, the eversion aid can have a fit (German: Passform), which corresponds to the shape of a body part intended for the garment. The handling mechanism thus forms the inner volume in a first step, which is accessible through the opening. Subsequently, the handling mechanism or the effector can be controlled such that the eversion aid can be inserted or positioned into the inner volume through the opening. The eversion aid thus provides the garment with stability in order to be able to be in the opened state. In a following step, the eversion device can thereby for example pass through the opening into the inner volume and carry out an eversion by means of gripping the pass-through portion. The eversion aid can represent an inflatable bellows or a tube. Furthermore, the eversion aid can represent a negative shape of the garment, wherein the negative shape in particular forms a shape of a body part for which the garment is intended (for example a foot shape for a sock, the shape of an upper body for a shirt or a leg for trousers as a garment). These mechanisms can also be combined as desired.

The eversion aid can for example also be fastened to the effector. Thus, for example for eversion of trousers, a double tube-like eversion aid consisting of parallel tubes can be introduced into the opening of the trousers as a garment. These two tubes are then only partly introduced into the leg tubes of the trousers (or vice versa: the effector, which opens the waistband as a free space, eversions this [including trousers turned to be on the left] over the two stationary tubes), then the rest of the trouser's legs, i.e. the pass-through portion of the garment, is sucked into the interior of the tubes and a relative movement between the free space and the beginning of the tube is carried out again (for example the tubes are pulled out of the waistband while maintaining the negative pressure) such that the trousers as a garment are everted.

According to a further exemplary embodiment, a proximity sensor and/or a contact sensor is formed on the eversion aid (for example on the surface of the garment) such that a position of the garment on the eversion aid can be determined. The seat of the garment on the eversion device can thus be checked before and after the eversion.

According to a further exemplary embodiment, the eversion aid comprises a surface with a coating, in particular Teflon, for reducing the frictional resistance with the garment. The effector, the handling mechanism and the eversion device and in particular the eversion aid thereof can be protected by additional measures in the sense of surface coatings from the garment becoming caught or hung. The surface coatings have a low frictional resistance. The surface coating can comprise, for example, a polished surface and/or a surface with a sliding coating made of Teflon. A reduction in the risk of adhesion can be achieved by these components having a substantially flat surface and/or repeller surfaces.

According to a further exemplary embodiment, the system has a fixing device, which is configured to fix the second fabric layer, while the first fabric layer can be spaced apart from the second fabric layer by means of the handling mechanism, wherein the fixing device is couplable to a work table or to a further effector of the handling robot. The work table forms a support surface for the second fabric layer. For example, the support surface can have suction openings in order to fasten the second fabric layer by means of negative pressure. Furthermore, for example, a clamping device fastened to the work table can be provided to press onto regions, for example edge regions, of the second fabric layer in order to clamp these firmly on the work table. The opening process can thus be facilitated, since slipping of the second fabric layer is prevented when the first fabric layer is lifted by means of the handling mechanism. Furthermore, this also offers advantages during the eversion process, since no displacements of the second fabric layer and thus no undesired changes in the inner volume during the eversion are thereby generated.

According to a further exemplary embodiment, the handling robot comprises two, in particular three, four or more, effectors,
wherein each of the effectors comprises a handling mechanism configured to space the first fabric layer from the second fabric layer. Each effector can be moved independently of each other. Complex garments, such as for example a shirt with long sleeves, can thus also be positioned such that an inner volume can be formed in the upper body region and on the sleeves. In other words, the inner volumes of the individual garment regions can be opened with the plurality of handling mechanisms of the effectors. Furthermore, the eversion device can be configured with one or more effectors. For example, the eversion device can respectively form circle devices on the effectors. Accordingly, the gripping device can grip the pass-through portions (or for example suck them in) and simultaneously retract the respective effectors in for example two sleeves or two trouser legs (at the farthest point), so that a uniformity of the movement for example reduces the ball formation. In a further exemplary embodiment, for example four effectors are provided which can grip the garment, for example a T-shirt. A first effector can grip and open a lower seam with a handling mechanism. A gripping device of the eversion device is configured on the second effector, so that a pass-through (German: Durchgriff) to the left sleeve and a corresponding fixing of the pass-through portion there takes place. A further gripping device of the eversion device is configured on the third effector, so that a pass-through to the right sleeve and a corresponding fixing of the pass-through portion there takes place. A further gripping device of the eversion device is configured on the fourth effector, so that a pass-through to the collar and a corresponding fixing of the pass-through portion there takes place. The gripped pass-through portions can be pulled through the opening on the seam in a common movement process, so that a homogeneous eversion can be carried out.

According to a further exemplary embodiment, the system has a further processing device, wherein the handling robot is configured to transport the everted garment from the eversion device to the further processing device. The further processing device is configured for cutting, grinding, embroidering, printing, flocking, gumming, lasering, painting and/or gluing the garment. The garment is post-processed before or after the eversion. Since it is frequently fixed at the outermost points during the eversion process, this is a especially suitable starting position for additional further processing in the further processing device: for example, jeans can be cut (fashionably) in a slicing device as a further processing device (for shabby chic lock), ground in a grinding device as a further processing device, embroidered, flocked or glued (for example with strassstones) in a embroidering device or gluing device as a further processing device, lasered in a laser device as a further processing device, dyed in a spraying device as a further processing device, printed or gummed in a printing device as a further processing device. The advantage of this direct further processing is that the garment no longer has to be gripped again, which increases the reliability and improves the production performance.

According to a further exemplary embodiment of the method, in the step of spacing the first fabric layer is gripped by means of the handling mechanism and spaced from the second fabric layer, which is in particular fixable at a work table, to form the inner volume. In particular, in an exemplary embodiment, the opening to the inner volume is formed at the location of the garment by the largest opening diameter being present in the garment. A suitable inner volume for the subsequent eversion is thus generated. In the automatic production, it can be of particular advantage that it is already known that the garment is “on the left” and this is no longer to be recognized in a complex manner with image systems. Furthermore, it is helpful if the largest cross section of the opening of the garment for forming the inner volume is selected for the eversion step. The pass-through portion of the garment can thereby be passed through in a better way. The risk of fabric layers getting stuck or a fold being generated when passing through the pass-through portion is reduced.

According to a further exemplary embodiment of the method, the garment is shaken after the eversion, in particular by means of a shaking movement of the effector. Portions still getting stuck can thus be released in order to finalize an incomplete eversion process.

According to a further exemplary embodiment of the method, before the step of spacing the garment by means of a control unit data of the garment for handling, in particular for gripping the pass-through portion, or data relating to the eversion of the garment are obtained.

According to a further exemplary embodiment of the method, the garment is ironed by means of an ironing device before the step of spacing the garment. The ironed garment is conveyed by means of the handling robot from the ironing device to the eversion device. In a further preferred embodiment, the garment is already ironed (i.e. still “on the left”) before the eversion. A later ironing can thereby be avoided, since the method according to the disclosure carries out an eversion process especially gently with regard to fold formation. Furthermore, the performance of an eversion process with an ironed garment reduces the risk of fabric parts, for example folds, getting stuck during the eversion process.

According to a further exemplary embodiment, a computer program for robot-assisted eversion of a garment is operated, which, when executed by a processor, is adapted to perform the method described above. The method described above can accordingly be integrated as a computer-implemented method.

It is pointed out that the embodiments described here represent only a limited selection of possible embodiment variants of the disclosure. It is thus possible to combine the features of individual embodiments with each other in a suitable manner, so that a plurality of different embodiments are to be regarded as obviously disclosed for the person skilled in the art with the embodiment variants explicit here. In particular, some embodiments of the disclosure are described with device claims and other embodiments of the disclosure with method claims. However, the person skilled in the art will immediately understand when reading this application that, unless explicitly stated otherwise, in addition to a combination of features belonging to one type of inventive subject matter, also any combination of features belonging to different types of inventive subject matter is possible.

### BRIEF DESCRIPTION OF THE DRAWINGS

In the following, exemplary embodiments are described in more detail with reference to the attached drawings for further explanation and for better understanding of the present disclosure. In the figures:

FIG. 1 shows a schematic illustration of a system, wherein the handling mechanism generates an inner volume of the garment, according to an exemplary embodiment of the present disclosure;

FIG. 2 shows a schematic illustration of a system, wherein an eversion process is illustrated with an eversion device, according to an exemplary embodiment of the present disclosure;

FIG. 3 shows a schematic illustration of a system, wherein a garment is illustrated after the eversion process from FIG. 2, according to an exemplary embodiment of the present disclosure;

FIG. 4 shows a schematic illustration of a system, wherein an eversion process is illustrated with an eversion device with a gripping device, according to an exemplary embodiment of the present disclosure;

FIG. 5 shows a schematic illustration of a system, wherein an eversion process is illustrated with an eversion device with a gripping device, wherein the handling mechanism holds the outer portion during eversion, according to an exemplary embodiment of the present disclosure;

FIG. 6 shows a schematic illustration of a system, wherein an eversion process is illustrated based on gravitational force, according to an exemplary embodiment of the present disclosure;

FIG. 7 shows a schematic illustration of a system with two effectors, the handling mechanisms of which form the inner volume of a garment, according to an exemplary embodiment of the present disclosure;

FIG. 8 shows a schematic illustration of a handling mechanism with a gripper, according to an exemplary embodiment of the present disclosure;

FIG. 9 shows a schematic illustration of a handling mechanism with a holding needle device, according to an exemplary embodiment of the present disclosure;

FIG. 10 shows a schematic illustration of a handling mechanism with a suction plate, according to an exemplary embodiment of the present disclosure;

FIG. 11 shows a schematic illustration of a handling mechanism with a suction unit, according to an exemplary embodiment of the present disclosure;

### DETAILED DESCRIPTION OF EXEMPLARY EMBODIMENTS

Identical or similar components in different figures are provided with the same reference numerals. The illustrations in the figures are schematic.

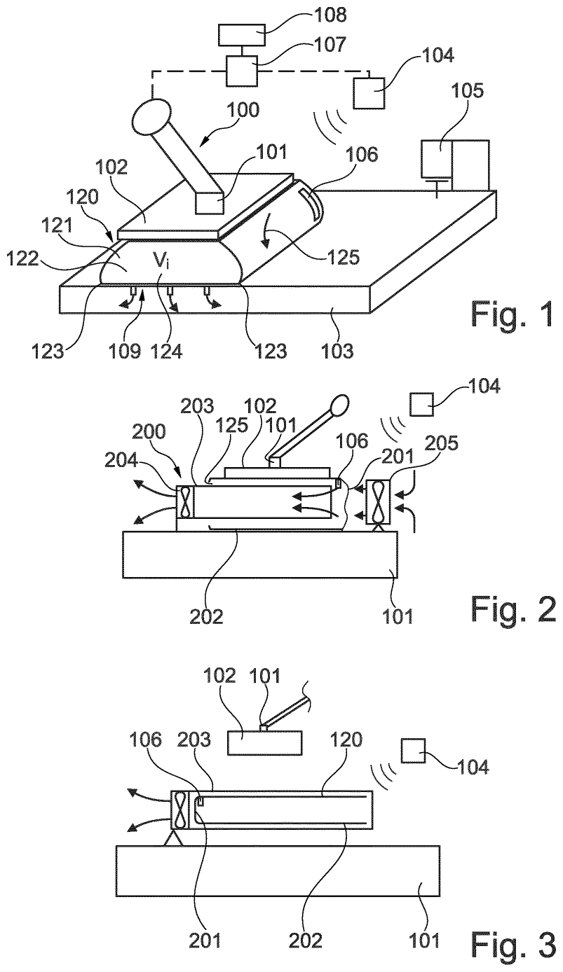

FIG. 1 shows a schematic illustration of a system, wherein a handling mechanism 102 generates an inner volume Vi of a garment 102. FIG. 2 shows a schematic illustration of a system, wherein an eversion process is illustrated with an eversion device 200.

The system thus provides robot-assisted eversion of a garment 120 consisting of superimposed first and second fabric layers 121, 122. The system comprises a handling robot 100 with an effector 101 comprising a handling mechanism 102 configured to space the first fabric layer 121 from the second fabric layer 122 to provide an inner volume between the first fabric layer 121 and the second fabric layer 122 accessible through an opening 124 between the fabric layers. Furthermore, the system comprises an eversion device 200 configured such that a pass-through portion 201 of the garment 120 relative to an outer portion 202 of the garment 120 can be passed through the inner volume and through the opening 124 such that an eversion of the garment 120 can be carried out.

The handling robot 100 comprises the effector 101 to which the corresponding handling mechanism 102 is attached, in particular exchangeably. The handling robot 100 is fastened to the floor or to a work table 103 with a stationary robot base to introduce corresponding forces into the corresponding system. The handling robot 100 can also be configured such that the robot base is configured to be movable along the floor. A robot arm can be arranged between the effector 101 and the robot base, which for example comprises one or more joints to thus control the effector 101 into a desired position. The handling robot 100 is thus configured to handle or manipulate the fabric layers 121, 121 and to move and position them accordingly. In other words, the handling robot 100 enables a machine-controlled position change possibility in more than one axis and/or along a translational position change of the fabric layers 121, 121.

The garment 120 according to the disclosure accordingly comprises the fabric layers 121, 121 which are laid on top of each other and which are fastened for example along two joining regions, e.g. seams 123. Furthermore, the two fabric layers 121, 121 can be formed in one piece from a folded fabric layer, wherein the two fabric layers 121, 121 are joined together with a common seam 123 (for example round socks).

The handling mechanism 102 grips the uppermost fabric layer 121, so that a spacing and accordingly the inner volume Vi is formed. As an alternative to gripping, the handling mechanism 102 can comprise other mechanisms, such as e.g. a compressed air device, which blows an air cushion between the first and the second fabric layer 121, 122 by means of compressed air.

Furthermore, the handling mechanism 102 can fasten at least one of the fabric layers 121 and accordingly the entire garment 120 in such a way that handling or transporting of the entire garment is possible.

The second fabric layer 122 lies on the work table 103 and is fixed on the work table 103 by means of a fixing device 109, while the first fabric layer 121 is spaced apart from the second fabric layer 122 by means of the handling mechanism 103. The work table forms a support surface for the second fabric layer and can have suction openings in order to fasten the second fabric layer 122 by means of negative pressure. Furthermore, for example, a clamping device fastened to the work table 103 can be provided to press onto regions, for example edge regions, of the second fabric layer 122 in order to clamp these firmly on the work table 103.

The handling mechanism 102 thus forms an accessible inner volume Vi of the garment 120, so that the eversion device can evert the garment. A pass-through portion 201 of the garment 120 relative to an outer portion 202 of the garment is passed through the inner volume Vi and through the opening 124 by means of the eversion device 200 such that an eversion of the garment 120 is carried out. The pass-through portion 201 describes the portion of the garment 120 which is passed through the opening 124 for eversion. Either the pass-through portion 201 of the garment 120 can be fixed and the outer portion 202 can be moved relative to the pass-through portion 201 or the outer portion 202 is fixed and the pass-through portion 201 of the garment 120 is moved relative to the outer portion 202.

The handling robot 100 is coupled to a control unit 107, which knows the operating parameters and position data of the individual functional units, such as for example a sewing machine or the eversion device 200, or can obtain them from sensor units 104 or from a database unit 108 having a database. One and the same handling robot 100 can accordingly feed the garment 120 and/or the fabric layers 121, 122 to a joining unit and then to the eversion device 200. Furthermore, the handling robot 100 is controllable by the control unit 107 in such a way that the handling robot 100 handles and positions the fabric layers 121, 122 during the sewing (joining) and also during the eversion process.

An eversion progress can be determined by means of the sensor unit 104, wherein the sensor unit 104 detects sensor data which are indicative of the eversion progress or of a fold formation of a fold 125 of the garment. The sensor unit 104 in particular comprises an optical sensor for optically recording the garment 120, a 3D sensor, a distance sensor (in the Z-direction, i.e. for example the distance between the effector and the first or second fabric layer) and/or a scanning sensor for scanning a contour of the garment. The progress of an eversion process can be detected by means of an analysis of the sensor data, in particular by means of the control unit 104. It can thus be ensured whether the garment 120 is completely everted.

For example, the sensor unit 104 can be configured to determine a marker element 106 on the garment 120, which marker element is indicative of an eversion progress. The sensor unit 104 for example comprises an optical sensor for determining a color pattern as marker element 106 on the garment 120. The marker element 106 is for example fastened at a predetermined location in the garment 120, so that conclusions about the quality and the progress of the eversion can be drawn based on the position and/or the shape of the marker element 106.

The control unit 107 is configured to obtain from a sensor unit 104 or from the database unit 108 garment data relating in particular to fabric layer material and/or fabric layer geometry, left/right orientation, local positioning, unfolding and/or production quality of the garment. The control unit 104 is further configured to collect and/or evaluate garment data with regard to manipulation, positioning, placement, fixing and/or sewing by the handling robot 100, wherein the control unit 107 is configured to control the handling robot 100, the eversion device 200 and/or the sewing machine 105 based on the garment data. Coordinates for the step of opening and/or eversion are thus obtained from a preceding production step, preferably coordinates for a gripping position for the eversion and/or the opening of the inner volume Vi. If the method according to the disclosure or the system is directly attached to an automated production, a set of coordinates can be adopted from the automated production, which set of coordinates contains suitable gripping points for the gripping through before the pulling.

The eversion device 200 comprises a suction device 204, wherein the eversion device 200 is configured such that the pass-through portion 201 can be sucked through the opening 124 by means of a suction force. The suction device 204 accordingly sucks the pass-through portion 201, so that the pass-through portion 201 can be moved relative to the opening 124 such that it is sucked through the opening 124 in order to achieve an eversion.

Furthermore, the eversion device 200 can comprise a compressed air device 205, wherein the eversion device 200 is configured such that the pass-through portion 201 can be blown through the opening 124 by means of compressed air. The compressed air device 205 can accordingly move the movable region, i.e. the pass-through portion 201, by means of compressed air such that the pass-through portion 201 can be moved relative to the opening 124 such that it is blown through the opening 124 in order to achieve an eversion.

Furthermore, the eversion device 200 comprises an eversion aid 203, which is introduced between the first fabric layer 121 and the second fabric layer 122 in order to stabilize the inner volume Vi or to hold the garment 120 in the opened, spanned state. The handling robot 100 is configured to fasten the garment 120 to the eversion aid 203, in particular by means of pulling over the garment. The eversion aid 203 consists of a tube, via which the handling mechanism 102 can over up the garment 120. The handling mechanism 102 thus forms the inner volume Vi in a first step, which is accessible through the opening 124.

The suction device 204 can for example be arranged at one end of the tube of the eversion aid 203 in order to pull air through the tube. On the other side of the tube, the latter is open and the pass-through portion 201 can be present there. The suction device 204 thus sucks the pass-through portion 201 into the tube during the eversion. The outer portion 202 slides along the outer surface of the tube up to the opening 124, which is present at the open end of the tube.

FIG. 3 shows the garment 120 after the eversion process from FIG. 2. The garment 120 lies in the interior of the tube after the eversion and can for example be gripped therefrom with the handling mechanism 102 and transported further.

A proximity sensor and/or a contact sensor can be formed on the eversion aid 203 (for example on the surface of the garment 120) such that a position of the garment 120 on the eversion aid 203 can be determined. The seat of the garment 120 on the eversion device 203 can thus be checked before, during and after the eversion. After the eversion, the garment 120 can be shaken, in particular by means of a shaking movement of the effector 101.

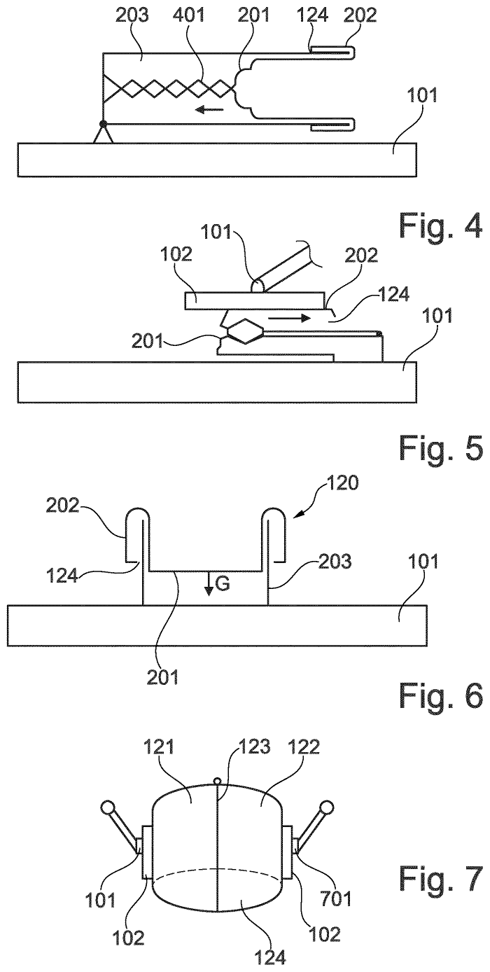

FIG. 4 shows a schematic illustration of a system, wherein an eversion process is illustrated with an eversion device 200 with a gripping device 401. The garment 120 is pulled over a tube as eversion aid 203. The gripping device 401 is configured to grip the pass-through portion 201 through the opening 124 and to guide it through the opening 124 relative to the outer portion 202. The gripping device 401 is arranged in particular at the effector 101. The gripping device comprises e.g. a gripper, which is arranged at a holding rod adjustable in length. The holding rod can for example be telescopically retracted and extended.

FIG. 5 shows a schematic illustration of a system, wherein an eversion process is illustrated with an eversion device 200 with a gripping device 401, wherein the handling mechanism 102 holds the outer portion 202 during eversion and releases it in portions during eversion. For spacing, the first fabric layer 121 is thus at first gripped by means of the handling mechanism 102 and spaced from the second fabric layer 122, which is in particular fixable at a work table 103, to form the inner volume Vi. In particular, the opening 124 to the inner volume Vi is formed at the location of the garment 120 by the largest opening diameter being present in the garment 120.

Subsequently, the gripping device 401 grips the pass-through portion 201 in the inner volume Vi and pulls it through the opening 124, while the handling mechanism 102 gradually releases the outer portion 202, until the eversion process is implemented.

FIG. 6 shows a schematic illustration of a system, wherein an eversion process is illustrated based on gravitational force G.

The eversion device 200 comprises for example a fixing device or a tube as eversion aid 203 with a fall-through opening, wherein the tube is vertically arranged. The eversion device 200 comprises fixing elements, such as for example grippers, which fasten the outer portion 202 of the garment 120 to the edge of the fall-through opening, in particular such that the opening 124 of the garment 120 and the fall-through opening form a common passage. The handling mechanism 102 can position the pass-through portion 201 such that it is present above the fall-through opening in the direction of gravity G. The handling mechanism 102 now releases the pass-through portion 201 completely or partially such that the released portion of the pass-through portion falls through the opening 124 of the garment 120 and through the fall-through opening in the direction of gravity (direction of gravity) G relative to the outer portion 202 such that an eversion of the garment 120 occurs. After the performed eversion process, the outer portion 202 can be released from the eversion device 200 and the garment 120 can be transported further by means of the handling device.

FIG. 7 shows a schematic illustration of a system with two effectors 101, 701, the handling mechanisms 102 of which form the inner volume of a garment 120. Each handling mechanism 102 grips a fabric layer 121, 122. The effector 101 and the effector 701 are controlled such that they move the fabric layers 121, 122 apart from each other to form the inner volume Vi. A further effector could comprise the eversion device 200 in order to then grip the pass-through portion 201 and pull it through the inner volume Vi for eversion.

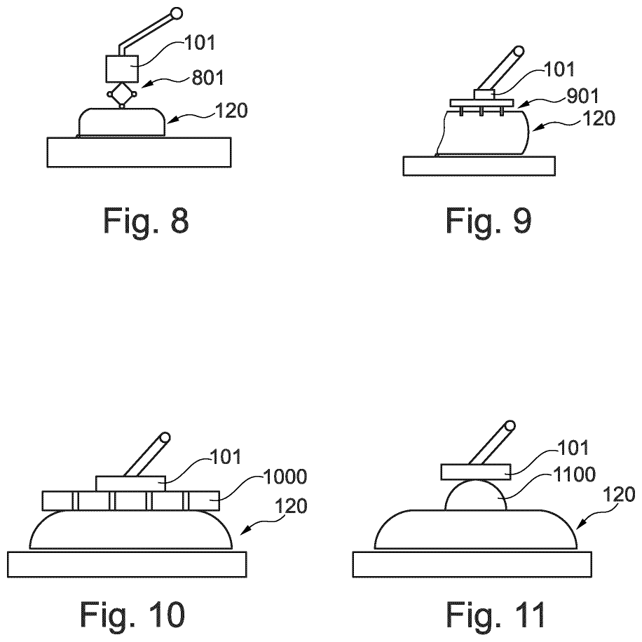

FIG. 8 shows a schematic illustration of a handling mechanism 102 with a gripper 801. The gripper 801 is configured such that it grips a fabric layer 121, 122 of the garment 120, so that the inner volume Vi can be formed by means of a movement of the effector 101.

FIG. 9 shows a schematic illustration of a handling mechanism 102 with a holding needle device 901. The holding needle device 901 is configured such that a penetration depth and/or a penetration angle of at least one holding needle e.g. of the first fabric layer 121 is controllable, in particular in real time and/or based on a sensor feedback. An additional form of differentiated gripping with the handling mechanism 102 can represent the depth of a holding needle and/or the angle of a holding needle into the fabric layer 121, 122.

FIG. 10 shows a schematic illustration of a handling mechanism 102 with a suction plate 1000, according to an exemplary embodiment of the present disclosure. The suction surface 1601 comprises a plurality of suction openings, so that a fabric layer 121, 122 for fastening to the effector 101 can be sucked by means of negative pressure.

FIG. 11 shows a schematic illustration of a handling mechanism 102 with a suction unit 1100. By means of the suction unit 1100, air can be sucked from the first fabric layer 121 such that the uppermost first fabric layer 121 is fastened to the effector 101 and can be spaced from the second fabric layer 122 to form the inner volume Vi.

In addition, it should be noted that “comprising” does not exclude any other elements or steps and “a” or “an” does not exclude a plurality. Furthermore, it should be noted that features or steps which have been described with reference to one of the above exemplary embodiments can also be used in combination with other features or steps of other exemplary embodiments described above. Reference signs in the claims are not to be regarded as a restriction.

List of reference signs:

100 Handling robot
101 Effector
102 Handling mechanism
103 Work table
104 Sensor unit
105 Sewing machine
106 Marker element
107 Control unit
108 Database unit
109 Fixing device
120 Garment
121 First fabric layer
122 Second fabric layer
123 Seam
124 Opening
125 Fold
200 Eversion device
201 Pass-through portion
202 Outer portion
203 Eversion aid
204 Suction device
205 Compressed air device
401 Gripping device
701 Further effector
801 Gripper
901 Holding needle device
1000 Suction plate
1100 Suction unit
G Gravitational force
Vi Inner volume

1-27. (canceled)

28. A system for robot-assisted eversion of a garment consisting of superimposed first and second fabric layers, wherein the system comprises:
a handling robot with an effector comprising a handling mechanism configured to space the first fabric layer from the second fabric layer to provide an inner volume between the first fabric layer and the second fabric layer accessible through an opening between the fabric layers; and
an eversion device,
wherein the eversion device is configured such that a pass-through portion of the garment relative to an outer portion of the garment can be passed through the inner volume and through the opening such that an eversion of the garment can be carried out.

29. The system according to claim 28,
wherein the handling mechanism is configured to handle at least the first fabric layer and to space it from the second fabric layer,
wherein the handling mechanism is selected from the group consisting of at least one of grippers, sucking units, clamps, regions with at least one of increased friction and electrostatic attraction, rollers, freezing grippers, and Bernoulli grippers.

30. The system according to claim 28,
wherein the handling mechanism comprises a holding needle device which is configured such that at least one of a penetration depth and a penetration angle of at least one holding needle into at least one of the first fabric layer and the second fabric layer is controllable,
wherein the holding needle device is configured to move the holding needles with a stroke length of less than 6 mm.

31. The system according to claim 28, further comprising:
a sewing machine which is couplable to a work table,
wherein the handling mechanism is configured to feed a fabric layer stack consisting of the first fabric layer and the second fabric layer to the sewing machine, wherein joining regions of the fabric layers are freely accessible for the sewing machine,
wherein the sewing machine is configured to sew the joining regions, and
wherein the handling mechanism is configured to guide the fabric layer stacks relative to the sewing machine during the sewing.

32. The system according to claim 31,
wherein the handling mechanism is configured to convey the sewn fabric layer stack from the sewing machine to the eversion device.

33. The system according to claim 28,
wherein the handling mechanism is configured to convey the everted garment from the eversion device to a further processing location.

34. The system according to claim 28, further comprising:
a sensor unit for determining an eversion progress at the eversion device, wherein the sensor unit detects sensor data which are indicative of the eversion progress or for a fold formation of the garment,
wherein the progress of an eversion process can be detected by means of analysis of the sensor data.

35. The system according to claim 34,
wherein the sensor unit is configured to determine a marker element on the garment, which marker element is indicative of an eversion progress;
wherein the sensor unit is selected from the group consisting of:
an optical sensor for determining a color pattern as marker element on the garment, an optical marking as marker element on the garment in the non-visible region of the light,
a magnetic sensor for determining a magnetic element as marker element in the garment, and
a force sensor for determining a stiffness range of the garment as marker element.

36. The system according to claim 28, further comprising
a further sensor unit for determining a material of the garment,
wherein the further sensor unit is coupled to the handling mechanism such that the handling mechanism is controllable based on the material of the garment.

37. The system according to claim 28, further comprising
a control unit, which is configured to obtain from a sensor unit or from a database unit garment data,
wherein the control unit is further configured to at least one of collect and evaluate garment data with regard to at least one of manipulation, positioning, placement, fixing and sewing by the handling robot, and
wherein the control unit is configured to control at least one of the handling robot, the eversion device and the sewing machine based on the garment data.

38. The system according to claim 28,
wherein the eversion device is configured such that the garment can be aligned such that the pass-through portion can be passed through the opening by means of gravitational force such that an eversion of the garment can be carried out.

39. The system according to claim 28,
wherein the eversion device comprises a suction device,
wherein at least one of:
wherein the eversion device is configured such that the pass-through portion can be sucked through the opening by means of suction force, and
wherein the eversion device is configured such that the pass-through portion can be fixed and the outer portion can be guided over the pass-through portion by means of suction force.

40. The system according to claim 28, comprising at least one of the following features:
wherein the eversion device comprises a compressed air device,
wherein at least one of:
wherein the eversion device is configured such that the pass-through portion can be blown through the opening by means of compressed air, and
wherein the eversion device is configured such that the pass-through portion can be fixed and the outer portion can be guided over the pass-through portion by means of compressed air;
wherein the eversion device comprises a gripping device,
wherein at least one of:
wherein the gripping device is configured to grip the pass-through portion through the opening and to guide it through the opening relative to the outer portion, and
wherein the eversion device is configured such that the pass-through portion of the garment can be fixed and the gripping device is configured to grip the outer portion and to guide the outer portion over the pass-through portion.

41. The system according to claim 28,
wherein the eversion device comprises an eversion aid, which can be introduced between the first fabric layer and the second fabric layer in order to stabilize the inner volume,
wherein the handling robot is configured to fasten the garment to the eversion aid, and wherein the eversion aid has a fit, which corresponds to the shape of a body part intended for the garment.

42. The system according to claim 41,
wherein at least one of a proximity sensor and a contact sensor is formed on the eversion aid such that a position of the garment on the eversion aid can be determined.

43. The system according to claim 41,
wherein the eversion aid comprises a surface with a coating for reducing the frictional resistance with the garment.

44. The system according to claim 28, comprising at least one of the following features:
further comprising:
a fixing device, which is configured to fix the second fabric layer, while the first fabric layer can be spaced apart from the second fabric layer by means of the handling mechanism,
wherein the fixing device is couplable to a work table or to a further effector of the handling robot;
wherein the handling robot comprises two effectors,
wherein each of the effectors comprises a handling mechanism configured to space the first fabric layer from the second fabric layer;
further comprising
a further processing device,
wherein the handling robot is configured to transport the everted garment from the eversion device to the further processing device, and
wherein the further processing device is configured for at least one of cutting, grinding, embroidering, printing, flocking, gumming, lasering, painting and gluing the garment.

45. A method for robot-assisted eversion of a garment consisting of superimposed first and second fabric layers, wherein the method comprises:
spacing the first fabric layer from the second fabric layer by means of a handling mechanism of an effector at a handling robot to provide an inner volume between the first fabric layer and the second fabric layer accessible through an opening between the fabric layers; and
everting the garment by means of an eversion device,
wherein a pass-through portion of the garment relative to an outer portion of the garment is passed through the inner volume and through the opening by means of the eversion device such that an eversion of the garment is carried out.

46. The method according to claim 45, comprising at least one of the following features:
wherein in the step of spacing the first fabric layer is gripped by means of the handling mechanism and spaced from the second fabric layer to form the inner volume;
wherein the opening to the inner volume is formed at the location of the garment by the largest opening diameter being present in the garment;
further comprising
shaking the garment after the everting;
wherein before the step of spacing the garment by means of a control unit data of the garment for handling or data relating to the eversion of the garment are obtained;
further comprising
ironing the garment by means of an ironing device before the step of spacing the garment,
wherein the ironed garment is conveyed by means of the handling robot from the ironing device to the eversion device.

47. A computer program for robot-assisted eversion of a garment, which, when executed by a processor, is adapted to perform the method according to claim 45.
